(19) United States
(12) Patent Application Publication
(10) Pub. No.: US 2026/0359799 A1
(43) Pub. Date: Nov. 12, 2026

(54) MESSAGE PROCESSOR WITH APPLICATION PROMPTS

(71) Applicant: Snap Inc., Santa Monica, CA (US)

(72) Inventors: Evan Spiegel, Los Angeles, CA (US); William Wu, Los Angeles, CA (US)

(21) Appl. No.: 19/745,362

(22) Filed: Jul. 17, 2026

Related U.S. Application Data
(63) Continuation of application No. 17/325,658, filed on May 20, 2021, now Pat. No. 12,718,206.
Application No. 17/325,658 is a continuation of application No. 15/868,909, filed on Jan. 11, 2018, now Pat. No. 11,017,363.
Application No. 15/868,909 is a continuation of application No. 14/466,940, filed on Aug. 22, 2014, now Pat. No. 10,055,717.

(51) Int. Cl. G06Q 20/10; G06F 7/02; G06Q 20/32; G06Q 20/42; G06Q 30/00

(52) U.S. Cl. CPC G06Q 20/10; G06F 7/02; G06Q 20/3224; G06Q 20/42; G06Q 30/00

(57) ABSTRACT

A computer implemented method includes identifying a special character in a message generated by a sender. A money transfer prompt is supplied to the sender in response to the special character. A transfer amount is validated. An account transfer for the transfer amount is initiated. The message is sent to a recipient with indicia of the account transfer.

### CROSS-REFERENCE OF RELATED APPLICATIONS

This application is a continuation of U.S. Patent Application Serial No. 17/325,658, filed May 20, 2021, which is a continuation of U.S. Patent Application Serial No. 15/868,909, filed Jan. 11, 2018, now issued as U.S. Patent No. 11,017,363, which is a continuation of U.S. Patent Application Serial No. 14/466,940, filed Aug. 22, 2014, now issued as U.S. Patent No. 10,055,717, each of which is incorporated by reference herein in its entirety.

### FIELD OF THE INVENTION

This invention relates generally to communications in a computer network. More particularly, this invention relates to a message processor with application prompts.

### BACKGROUND OF THE INVENTION

Electronic messages have become a pervasive form of communication. Frequently, such communications implicate the need for an application that supports a service required by the message sender. Therefore, it would be desirable for one to easily invoke an application from an electronic message.

### SUMMARY OF THE INVENTION

A computer implemented method includes identifying a special character in a message generated by a sender. An application prompt is supplied to the sender in response to the special character. An application is invoked in response to activation of the application prompt.

In one example, a computer implemented method includes identifying a special character in a message generated by a sender. A money transfer prompt is supplied to the sender in response to the special character. A transfer amount is validated. An account transfer for the transfer amount is initiated. The message is sent to a recipient with indicia of the account transfer.

In yet another example, a computer implemented method contemplates invoking an application directly from a message thread interface, without a requirement of navigating away from the message thread interface.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates a message interface that may be used in accordance with an embodiment of the invention.

FIG. 4 illustrates an account transfer prompt utilized in accordance with an embodiment of the invention.

FIG. 5 illustrates an account information prompt utilized in accordance with an embodiment of the invention.

FIG. 6 illustrates a message with indicia of an account transfer.

FIG. 7 illustrates processing operations associated with an alternate embodiment of the invention.

Like reference numerals refer to corresponding parts throughout the several views of the drawings.

### DETAILED DESCRIPTION OF THE INVENTION

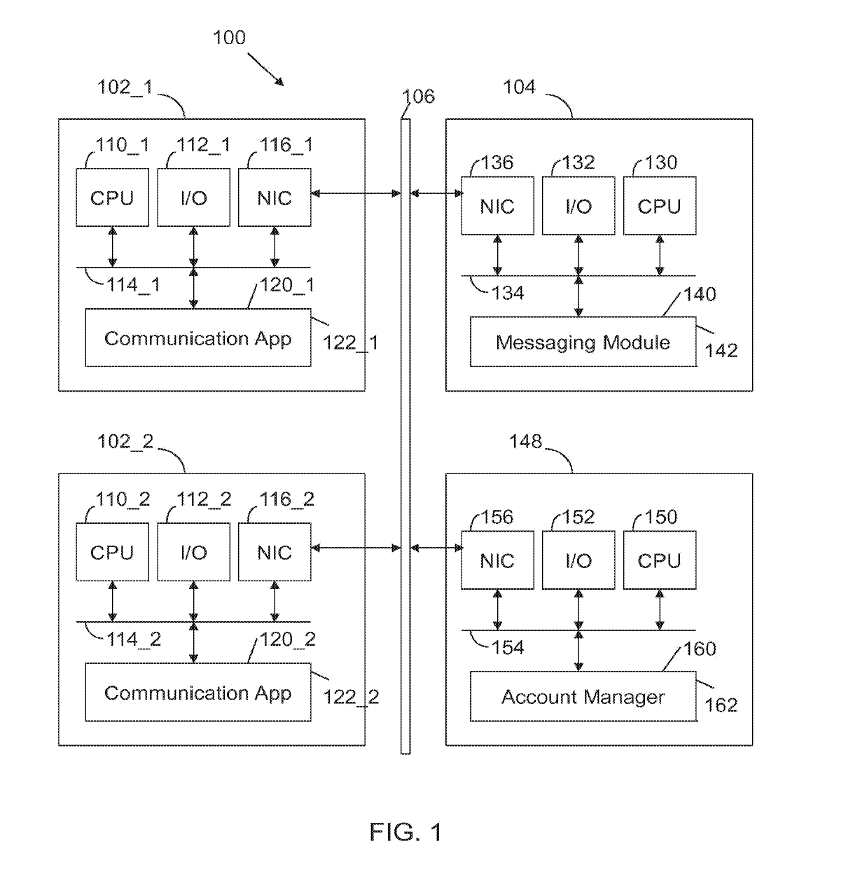

FIG. 1 illustrates a system 100 configured in accordance with an embodiment of the invention. The system 100 includes a first client device 102_1 and a second client device 102_2. The client devices 102 may be used to exchange messages via a server 104 and network 106, which may be any combination of wired and wireless networks. Server 104 communicates with server 148 via network 106 to coordinate account transfers, as discussed below.

Each client device 102 includes standard components, such as a central processing unit 110 and input/output devices 112 connected via a bus 114. The input/output devices 112 may include a touch display, keyboard and the like. A network interface circuit 116 is also connected to the bus 114 to coordinate communications over network 106. A memory 120 is also connected to the bus 114. The memory 120 stores a communication application 122. The communication application 122 is a messaging application that coordinates the exchange of messages via server 104. The messages may be text messages, pictures or videos (with or without associated text), and the like. Each client device 102 may be a smartphone, tablet, wearable device, PC, and the like.

The server 104 also includes standard components, such as a central processing unit 130, input/output devices 132, a bus 134 and a network interface circuit 136. A memory 140 connected to the bus 134 store a messaging module 142. The messaging module stores instructions that are executed by the central processing unit 130 to implement operations of the invention. The messaging module 142 supports the exchange of electronic messages and coordinates account transfers that are initiated from electronic messages.

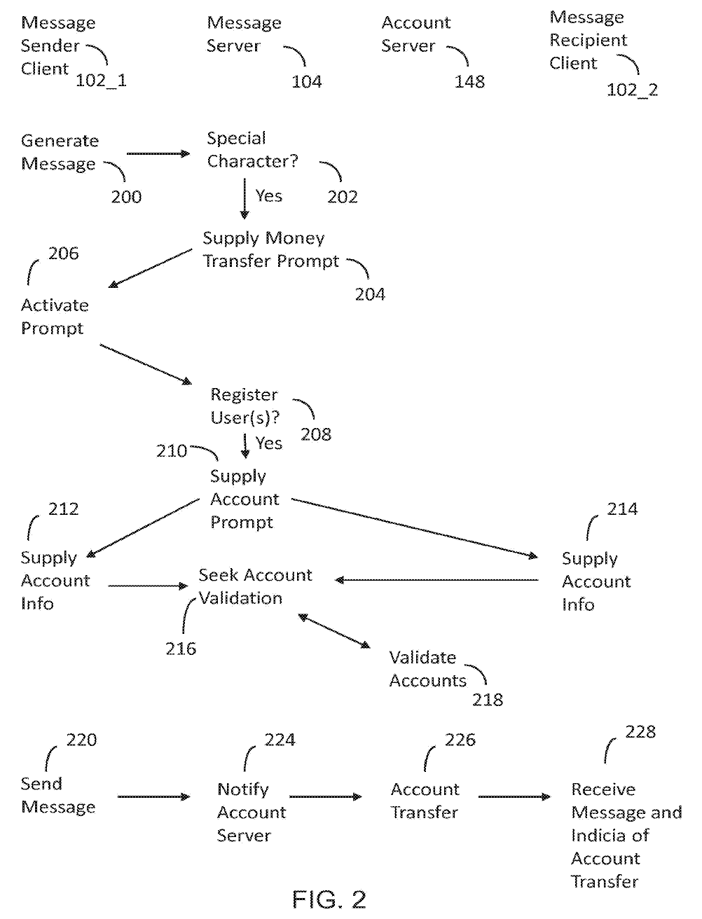

Server 148 also includes standard components, such as a central processing unit 150, input/output devices 152, a bus 154 and a network interface circuit 156. A memory 160 stores an account manager 162. The account manager 162 includes executable instructions to maintain account information and account balances. The account manager 162 includes an interface, such as an application program interface, which supports online account transfers. The messaging module 142 communicates with the account manager 162 to initiate such online account transfers from electronic messages, as demonstrated in connection with FIG. 2.

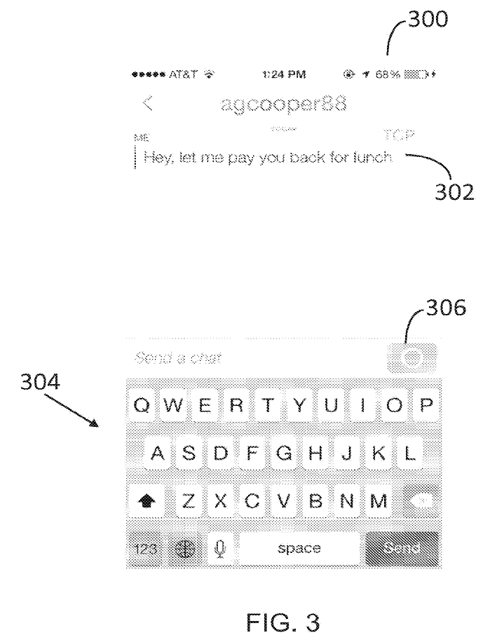

FIG. 2 illustrates interactive operations performed by the components of FIG. 1. Initially, a message is generated 200 at a client device, such as a message sender client 102_1. FIG. 3 illustrates a user interface 300 for a messaging application. The figure illustrates a text message 302 generated from keyboard 304. Adjacent to the keyboard is a message functionality prompt 306. In this case, activating the prompt invokes a photograph or video mode. Thus, one can send a message with a photo or video with or without accompanying text.

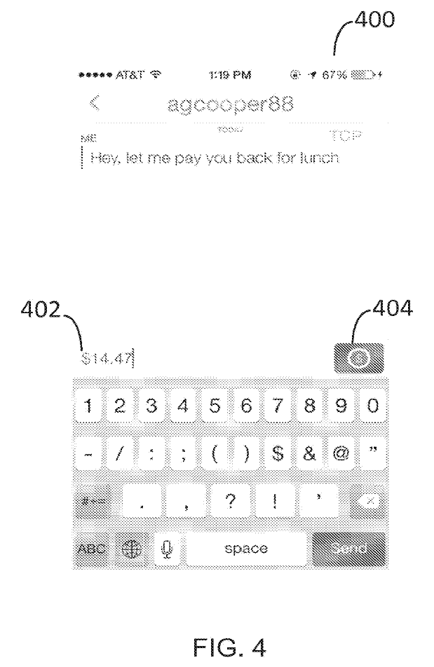

Returning to FIG. 2, the message server checks for a special character (which may include a single character or string of characters) in the message 202. For example, the special character may be a dollar sign or other designated keyboard character. If the character is present, then a money transfer prompt is supplied 204. In other embodiments, the message server may check for a valid dollar amount coupled with the dollar sign. FIG. 4 illustrates an interface 400 with a dollar sign 402 entered by the user. The presence of the special character results in a money transfer prompt 404 being supplied by the messaging module 142 of the message server 104. Observe that simply typing the special character allows one to initiate a financial transaction directly from a message. This circumvents the need to log into a separate web portal to define a financial transaction. Instead, the financial transaction is initiated directly from the message.

The next processing operation of FIG. 2 occurs at the message sender client 102_1, where the user activates the prompt 206. A check is made at the message server 104 to determine whether the user is registered 208. More particularly, the message server determines whether the message sender and message recipient have accounts that will allow for an account transfer. If registration is required, an account prompt is supplied 210 to the sender client 102_1 and/or the recipient client 102_2.

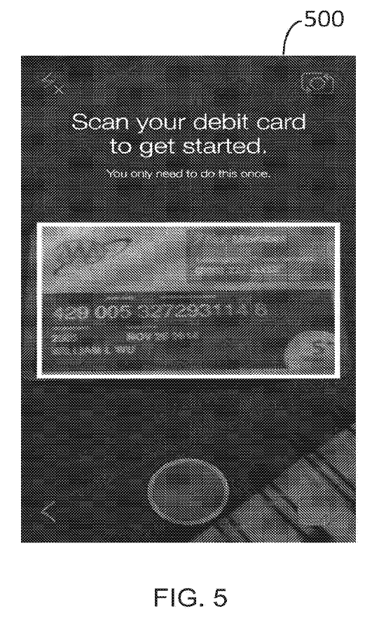

FIG. 5 illustrates an interface 500 that prompts a user to scan a debit or credit card. That is, the user is prompted to take a digital photograph of the card using the camera associated with the client device (or to use their camera to "hover over" the card number). Alternately, the prompt may solicit the sender to enter an account number. In the case of a digital photograph, the message server 104 uses an optical character recognition (OCR) analysis or machine vision analysis to decipher the account number. Either analysis may be augmented with prompts to the user to confirm the accuracy of the deciphered account number. Thus, a number is presented to the user, which may be edited by the user to correct errors arising from the analysis process.

Returning to FIG. 2, the account information is supplied by the sender 212 or recipient 214. The account information is then validated 216. That is, the message server 104 communicates with the account server 148 to validate accounts 218. The validation includes validation that the sender has sufficient funds for the account transfer. If the sender and recipient are already registered, then activation of the prompt 206 leads immediately to the seeking of account validation 216.

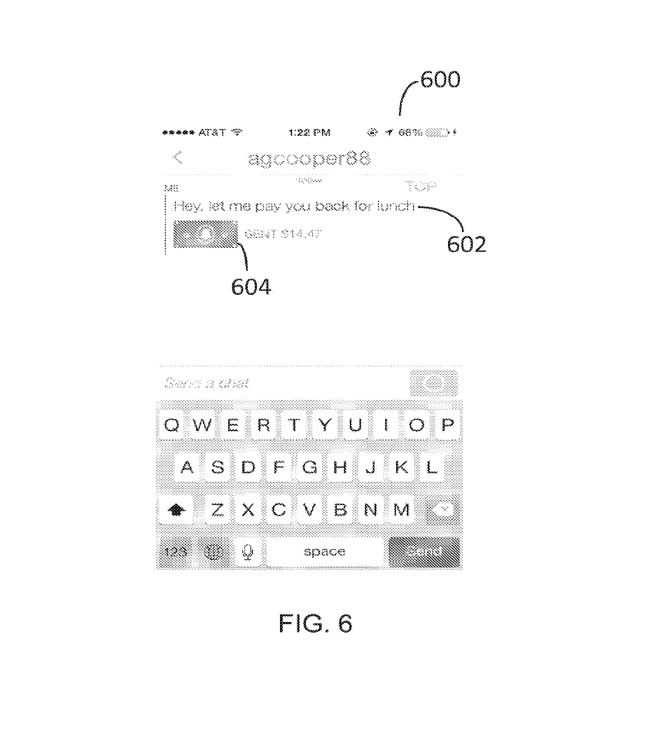

The message sender sends the message 220. The message server 104 coordinates message delivery and notifies the account server 224. The account server 148 executes the account transfer 226. The message is then received 228 at the recipient client 102_2. The message includes indicia of the account transfer. FIG. 6 illustrates an interface 600 with a message 602 and indicia of an account transfer 604.

In another aspect of the invention, arithmetic or calculator operations may be implemented as part of and in conjunction with the process of the instant invention. For example, the process of the invention may be implemented to recognize certain symbols upon which certain operations are performed. For instance, symbols such as "+", "-", "/" may trigger an arithmetic operation, thereby facilitating the division of a meal expense among the number of people at a meal, etc.

Thus, it can be appreciated that the invention provides an easy mechanism to effectuate a financial transaction directly from a message. The financial transaction is initiated from a message, not by a separate process of logging into a financial portal. Thus, the messaging application provides enhanced user functionality.

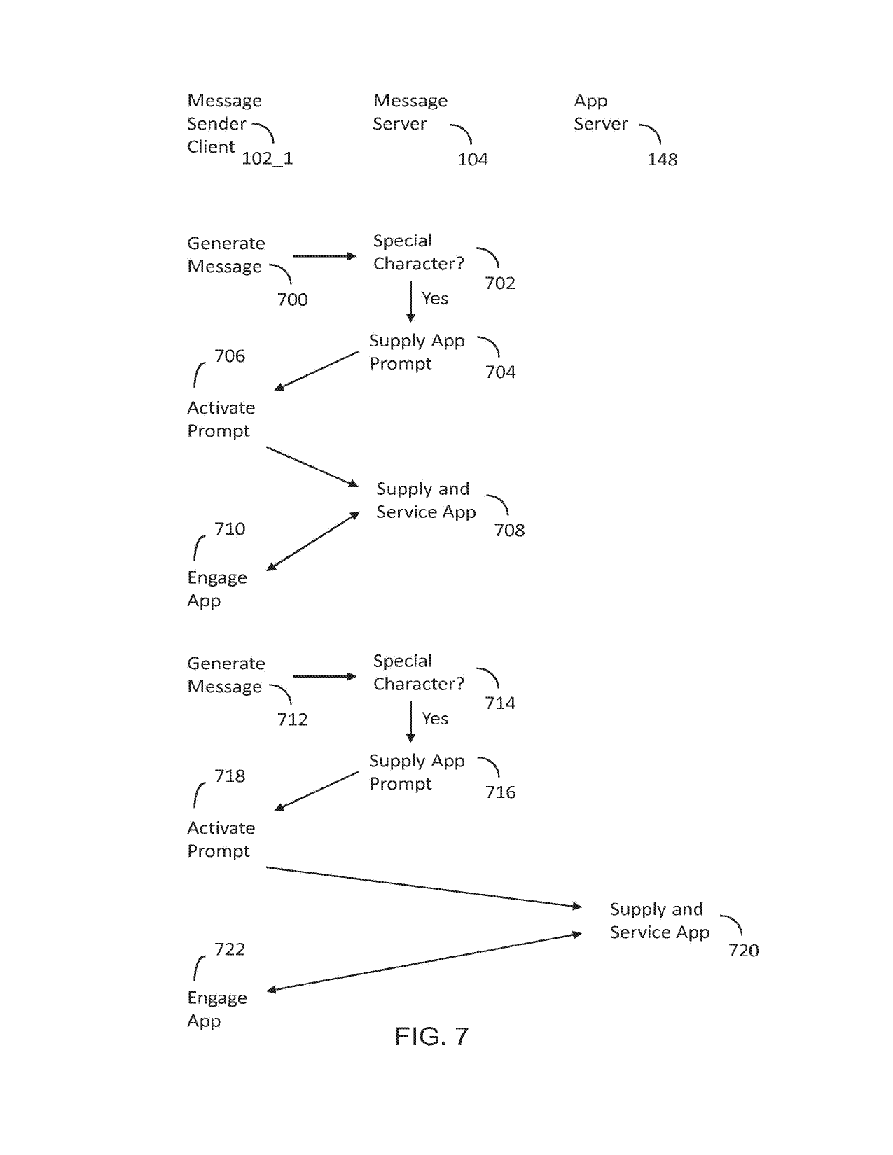

An alternate embodiment of the invention is depicted in FIG. 7. A message sender client 102_1 generates a message 700. The message server 104 determines if a special character is present 702. For example, the special character may be a hash tag(#), which invokes a map application. Alternately, the special character may be a percentage sign (%), which invokes a calculator application. Like with other embodiments described herein, a series of characters or characters coupled with a special character may be used to invoke an application. Examples include "#HERE" or "HERE" for invoking a map application (where a user can obtain or send directions to a location) or "+CAL" for invoking a calendar function (where a user can create a calendar event).

Another example could include ecommerce applications. For example, "#GIFT" could be used to launch a process whereby a user may purchase a gift for another user. In this embodiment, upon detecting the special character "#GIFT", the user is prompted to take a picture of a barcode associated with a purchasable item or service. After recognizing the barcode ( and the item to be purchased), the user may confirm or push a send button, which results in the item or service being sent to the user's recipient. An associated debit may then be made to the user's account.

In an alternative ecommerce example, "$FOOD" or "$PIZZA" could be used to order food service delivery. Upon detecting the special character, a geolocation feature could be used to identify nearby restaurants available for delivery. Tapping the button could launch one or more menus and/or order flow screens. In this example, the cost of food could be split between the user and recipient or charged entirely to the user. The food would then be delivered to the user based on profile information or alternatively according to geolocation information.

Yet another example could relate to people in a user's contact list. For example, "@" coupled with a contact name could invoke one or more other applications. One example includes adding the identified contact to a chat. Another example includes adding an image or picture of the contact to the chat.

It should be recognized that numerous other character and application pairs may be implemented within the present invention. In addition, the characters and associated applications may be customizable according to each user's individual preferences. For example, a user may choose to customize the "#GIFT" character to invoke a gift registry application, which adds an item or service to a list of items the user would like to receive as a gift.

Returning to FIG. 7, if a special character is present (702 - Yes), then an application prompt is supplied 704. If the message sender client 102_1 activates the prompt 706, the application is supplied and serviced 708 at the message sever 104. For example, the message server 104 may supply and service a calculator application in response to engagement of the application 710 at the message sender client 102_1.

The message sender client 102_1 may generate another message 712 with a different special character. If the special character is present (714 - Yes), an application prompt is supplied 716. Activation of the prompt 718 by the message sender client 102_1 may invoke a third-party application, such as a map service supported by an application server 148. The application server 148 supplies and services the application 720 in response to engagement of the application 722 at the message sender client 102_1.

Numerous other embodiments are possible. In addition, series of characters or text may be used in addition to special characters to invoke applications or operations. For example, the text string "www" may be recognized as a URL, upon which a screenshot of the website may be presented to the user. The user may then annotate or add text to the screenshot and subsequently forward to a recipient.

Thus, it can be seen that aspects of the present invention allow an application to be invoked directly from a message thread interface, without a requirement of navigating away from the message thread interface.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits ("ASICs"), programmable logic devices ("PLDs") and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A computer implemented method, comprising:
causing display of a messaging thread interface at a user device;
associating a special character with a financial application:
detecting the special character in a message generated by a user on the user device within the messaging thread interface;
in response to detecting the special character within the message generated by the user within the messaging thread interface, generating a money transfer prompt for the user comprising a transfer amount;
prompting the user to enter account information associated with a user account;
determining, by the financial application, the user account has at least the transfer amount; and
initiating an account transfer for the transfer amount.

2. The computer implemented method of claim 1, further comprising:
displaying an account registration prompt to a recipient of the message.

3. The computer implemented method of claim 2, further comprising:
in response to the account registration prompt, receiving a user input account information associated with the recipient; and
storing the account information associated with the recipient.

4. The computer implemented method of claim 1, further comprising:
notifying an account server to execute the account transfer for the transfer amount.

5. The computer implemented method of claim 1, further comprising:
associating, based on input from the user, an additional special character with a user-defined operation.

6. The computer implemented method of claim 1, wherein initiating the account transfer comprises using an account number for the account transfer.

7. The computer implemented method of claim 6, wherein the account number is generated via a picture scan taken by the user device.

8. The computer implemented method of claim 1, wherein initiating the account transfer comprises using an account number for the account transfer.

9. The computer implemented method of claim 8, wherein the account number is used to determine if the user is a registered user.

10. The computer implemented method of claim 1, further comprising:
in response to detecting the special character within the message generated by the user within the messaging thread interface, causing display of an icon associated with the financial application within the messaging thread interface while maintaining display of the messaging thread interface.

11. A system comprising:
at least one processor; and
memory including instructions that, when executed by the at least one processor, cause the at least one processor to perform operations comprising:
causing display of a messaging thread interface at a user device;
associating a special character with a financial application:
detecting the special character in a message generated by a user on the user device within the messaging thread interface;
in response to detecting the special character within the message generated by the user within the messaging thread interface, generating a money transfer prompt for the user comprising a transfer amount;
prompting the user to enter account information associated with a user account;
determining, by the financial application, the user account has at least the transfer amount; and
initiating an account transfer for the transfer amount.

12. The system of claim 11, further comprising:
displaying an account registration prompt to a recipient of the message.

13. The system of claim 12, further comprising:
in response to the account registration prompt, receiving a user input account information associated with the recipient; and
storing the account information associated with the recipient.

14. The system of claim 11, further comprising:
notifying an account server to execute the account transfer for the transfer amount.

15. The system of claim 11, further comprising:
associating, based on input from the user, an additional special character with a user-defined operation.

16. The system of claim 11, wherein initiating the account transfer comprises using an account number for the account transfer.

17. The system of claim 16, wherein the account number is generated via a picture scan taken by the user device.

18. The system of claim 11, wherein initiating the account transfer comprises using an account number for the account transfer.

19. The system of claim 18, wherein the account number is used to determine if the user is a registered user.

20. At least one non-transitory computer-readable storage medium, the at least one non-transitory computer-readable storage medium including instructions that when executed by a computing system, cause the computing system to perform operations comprising:
causing display of a messaging thread interface at a user device;
associating a special character with a financial application:
detecting the special character in a message generated by a user on the user device within the messaging thread interface;
in response to detecting the special character within the message generated by the user within the messaging thread interface, generating a money transfer prompt for the user comprising a transfer amount;
prompting the user to enter account information associated with a user account;
determining, by the financial application, the user account has at least the transfer amount; and
initiating an account transfer for the transfer amount.
